(19) United States
(12) Patent Application Publication
(10) Pub. No.: US 2024/0330655 A1
(43) Pub. Date: Oct. 3, 2024

(54) SYSTEM AND METHOD FOR EVALUATING GENERATIVE ARTIFICIAL INTELLIGENCE MODELS

(71) Applicant: MASTERCARD TECHNOLOGIES CANADA ULC, Vancouver (CA)

(72) Inventors: John Hearty, Vancouver (CA); Adeline Pelletier, Tel Aviv (IL)

(21) Appl. No.: 18/617,994

(22) Filed: Mar. 27, 2024

Related U.S. Application Data
(60) Provisional application No. 63/492,674, filed on Mar. 28, 2023.
(60) Provisional application No. 63/623,545, filed on Jan. 22, 2024.

(51) Int. Cl. G06N 3/045; G06N 3/042; G06N 3/08

(52) U.S. Cl. CPC G06N 3/045; G06N 3/042; G06N 3/08

(57) ABSTRACT

A system includes memory hardware configured to store instructions and one or more electronic processors configured to execute the instructions. The instructions include providing a plurality of training inputs to a first artificial intelligence model to generate a plurality of training outputs, organizing the preprocessed training inputs and/or training outputs in a feature space based on proximity using a second artificial intelligence model, providing a test input to the first artificial intelligence model to generate a test output, adding the preprocessed test output to the feature space as a test feature using the second artificial intelligence model, computing a first metric corresponding to a count of selected labeled features in the feature space, computing a second metric corresponding to distances between the selected labeled features and the test feature, computing a risk score based on the first metric and the second metric.

### CROSS-REFERENCE TO RELATED APPLICATIONS

This application claims the benefit of U.S. Provisional Application No. 63/492,674 filed Mar. 28, 2023, and U.S. Provisional Application No. 63/623,545, filed Jan. 22, 2024. The entire disclosures of the above applications are incorporated by reference herein.

### FIELD

The present disclosure relates to error detection and correction in data processing systems and, more particularly, to detecting and correcting systematic errors in artificial intelligence systems.

### SUMMARY

The systems and methods described in this specification may solve a variety of technical problems associated with detecting and correcting systematic errors in artificial intelligence systems. For example, while generative models can be powerful, it may be beneficial to evaluate them for ethical and quality risks—and it may be beneficial to mitigate these risks—before they are used in critical enterprise applications. However, since each output of a generative model tends to be unique (since generative models may use a variety of sampling techniques—such as stochastic sampling, top-k sampling, and/or nucleus sampling—to make their outputs more diverse), applying label-based training techniques to generative models tends to be challenging. Furthermore, generative model outputs are the cumulative product of multiple layers of processing. Since each individual layer of the neural network of the generative model does not necessarily produce a result that is by itself meaningful, interrogating each individual layer for risk factors does not necessarily lead to meaningful results. As a result, conventional methods may not be adequate to the task of evaluating generative models for risk factors, much less applying controls to the generative models to reduce identified risk factors. However, the systems and methods described herein address these needs by allowing for the real-time risk assessment of generative models and correcting the generative models to reduce or eliminate these risks.

In some aspects, the techniques described herein relate to a system including: memory hardware storing instructions and one or more electronic processors configured to execute the instructions, wherein the instructions include: providing a plurality of training inputs to a first artificial intelligence model to generate a plurality of training outputs, preprocessing the plurality of training inputs and/or training outputs, labeling one or more of the plurality of preprocessed training inputs and/or training outputs, organizing the preprocessed training inputs and/or training outputs as labeled and unlabeled features in a feature space based on proximity using a second artificial intelligence model, providing a test input to the first artificial intelligence model to generate a test output, preprocessing the test output, adding the preprocessed test output to the feature space as a test feature using the second artificial intelligence model, selecting labeled features in the feature space within a radius of the test feature, computing a first metric corresponding to a count of the selected labeled features, computing a second metric corresponding to distances between the selected labeled features and the test feature, computing a risk score based on the first metric and the second metric, in response to the risk score being above a threshold, assigning a first label to the test output, wherein the first label is indicative of an erroneous output from the first artificial intelligence model, and in response to the risk score not being above the threshold, (i) assigning a second label to the test output and (ii) transmitting the test output to a user device, wherein the second label is indicative of a non-erroneous output from the first artificial intelligence model.

In some aspects, the techniques described herein relate to a non-transitory computer-readable storage medium including executable instructions, wherein the executable instructions cause an electronic processor to: provide a plurality of training inputs to a first artificial intelligence model to generate a plurality of training outputs; preprocess the plurality of training inputs and/or training outputs; label one or more of the plurality of preprocessed training inputs and/or training outputs; organize the preprocessed training inputs and/or training outputs as labeled and unlabeled features in a feature space based on proximity using a second artificial intelligence model; provide a test input to the first artificial intelligence model to generate a test output; preprocess the test output; add the preprocessed test output to the feature space as a test feature using the second artificial intelligence model; select labeled features in the feature space within a radius of the test feature; compute a first metric corresponding to a count of the selected labeled features; compute a second metric corresponding to distances between the selected labeled features and the test feature; compute a risk score based on the first metric and the second metric; in response to the risk score being above a threshold, assign a first label to the test output, wherein the first label is indicative of an erroneous output from the first artificial intelligence model; and in response to the risk score not being above the threshold, (i) assign a second label to the test output and (ii) transmit the test output to a user device, wherein the second label is indicative of a non-erroneous output from the first artificial intelligence model.

Other examples, embodiments, features, and aspects will become apparent by consideration of the detailed description and accompanying drawings.

### BRIEF DESCRIPTION OF THE DRAWINGS

The present disclosure will become more fully understood from the detailed description and the accompanying drawings.

FIG. 1 is a function block diagram of an example system for evaluating generative artificial intelligence models.

FIG. 2 is a function block diagram of an example system for evaluating generative artificial intelligence models.

FIG. 3 is a function block diagram of an example system for evaluating generative artificial intelligence models.

FIG. 4 is a flowchart of an example process for evaluating artificial intelligence models.

FIG. 5 is a flowchart of an example process for evaluating artificial intelligence models.

FIG. 6 is a flowchart of an example process for performing preprocessing on output data sets from artificial intelligence models.

FIG. 7 is a flowchart of an example process for evaluating and retraining artificial intelligence models.

FIG. 8 is a graphical representation of an example neural network with no hidden layers.

FIG. 9 is a graphical representation of an example neural network with one hidden layer.

FIGS. 10A-10B are flowcharts of an example process for evaluating artificial intelligence models.

FIG. 11 is a flowchart of an example process for organizing preprocessed training inputs and/or outputs in a feature space based on proximity using a graph neural network.

FIG. 12 is a flowchart of an example process for organizing preprocessed training inputs and/or outputs in a feature space based on proximity using a topological clustering technique.

In the drawings, reference numbers may be reused to identify similar and/or identical elements.

### DETAILED DESCRIPTION

Various examples described in this specification relate to systems and methods for evaluating the outputs of artificial intelligence models for systematic errors, such as errors resulting from or relating to bias, fairness, suitability, and/or quality. In various implementations, the artificial intelligence models may include machine learning models, such as generative machine learning models. In some embodiments, generative machine learning models may include language-based generative models—such as large language models—or non-language-based generative models. In some examples, the systems and methods described herein may function by taking the output of a generative model, processing the output using various techniques, and then topologically mapping the processed output against identified risk factors to score and weight the degree of risk. In various implementations, the various techniques may include techniques similar to those used to train large language models. According to some embodiments, the identified risk factors may include bias, fairness, suitability, and/or quality. In some examples, the degree of risk may represent risk presented by a given, previously unseen output of the generative model.

Generally, the systems and methods described in this specification include post-processes that operate on outputs of machine learning models. In various implementations, the machine learning models may be language-based generative models such as large language models, and the outputs may include text, such as natural language text. The post-processes may include the following stages: (i) applying data pre-processing techniques to the outputs of the machine learning models, (ii) applying graph-based association techniques to the pre-processed outputs to generate graph embeddings, and (iii) applying classification and output weighting techniques to the graph embeddings.

In various implementations, the process of training natural language models—such as large language models—may include the following data processing steps: (a) stemming and/or lemmatization operations, (b) tokenization operations, (c) weighting operations, and/or (d) association operations (such as applying n-gram association techniques). Large language models may apply steps (a)-(d) to inputs provided to the model. These inputs may be used to train the models to stitch together input text tokens into apparently correct statements. However, the systems and methods described herein may—additionally or alternatively—apply any combination of (a)-(d) above to the outputs of machine learning models as pre-processing operations in stage (i) of the post-process described above.

At stage (ii) of the post-process described above, the output of the machine learning model may be evaluated for risk. In various implementations, a graph embedding of the terms in the pre-processed output produced at stage (i) may be generated. In various implementations, the higher-dimensional vector produced by the stemming, lemmatization, tokenization, weighting, and/or association operations described above may be transformed into a lower-dimensional space by using association-based graph machine learning techniques. These techniques may generate edges or links between each node. In various implementations, textual terms of the pre-processed outputs of the machine learning models may be represented as nodes on the graph embedding, and these nodes may be linked to other associated nodes by edges. In various implementations, graph mining and/or graph embedding techniques may be used to generate mappings of lower-order objects (e.g., terms) while retaining higher-order structure (e.g., sentence structures). In various implementations, these techniques group terms with their usage. This makes the identification of suitability versus unsuitability on a topic (and across multiple topics) possible. For example, as low-utility comments (such as biased or incorrect comments) may contain certain term combinations (and not other term combinations), they may be grouped closer to certain spatial locations in a graph space.

In various implementations, graph mining techniques suitable for assessing language for properties such as abusiveness may also rely on the relationships between various speakers. For example, speakers may be grouped into communities. These communities may be represented spatially in graph space. Each community may be assessed for abusiveness. Communities—including individual speakers within the community—may tend to be collectively more or less abusive. In large language model applications, there may only be a single speaker. In such examples, utterances by the large language model may be variably abusive. Consecutive utterances from a single speaker may be more likely to become more abusive, invalid, or incorrect if they start to deviate from high utility.

At stage (iii) of the post-process described above, statement classification may be performed on the graph embedding. In various implementations, the graph embedding may be a graph embedding of terms produced by a large language model, and the graph embedding may be generated based on the associated use of those terms. Statement classification may be performed on the graph embedding using approaches such as graph deep learning. Such approaches generally require a corpus or corpora of labeled data. A training protocol for generating such a corpus or corpora in a time-efficient way includes: (1) generating labels in a single domain by retrieving statements on one topic, (2) generating labels in an additional domain by retrieving statements on another topic, (3) training a machine learning model that evaluates statements across multiple domains, (4) continuing to add additional domains while holding out a multi-domain dataset to test generalization abilities of the machine learning model, and (5) continuing to train the machine learning model until generalization ability reaches a threshold.

Various implementations of systems and methods for evaluating the outputs of various artificial intelligence models for systematic include: (I) a large language model—such as an artificial intelligence chatbot trained using both supervised and reinforcement learning techniques, (II) an interface—such as an application programming interface—configured to remotely query the large language model and send responses to (III) a trained machine learning model able to classify the responses for systematic errors—such as bias and/or utility, (IV) a process that serves the response to the trained machine learning model, and/or (V) a process that (A) serves the response to a user if the trained machine learning model considers the response to be valid or (B) requests a new response from the large language model if the trained machine learning model considers the response to be not valid.

In various implementations, a generative adversarial model or an autoencoder may be used instead of or in addition to the graphical approach described at stages (ii) and (iii) of the post-process described above. In various implementations, the generative adversarial model or autoencoder may operate on a vector representation of the text output from the large language model (instead of or in addition to the graph embedding).

### System

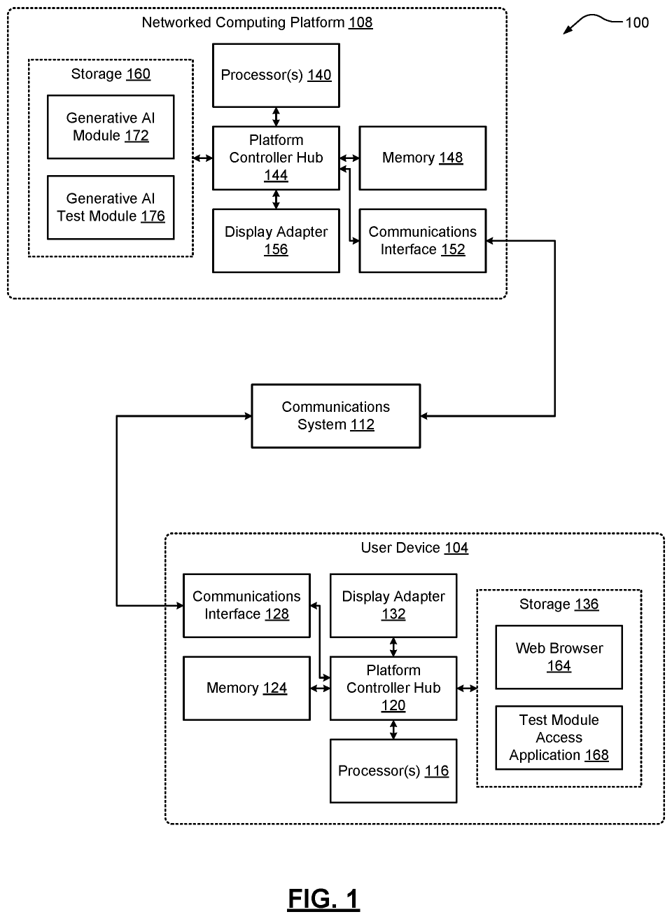

FIGS. 1-3 are function block diagrams of example systems 100 for evaluating generative artificial intelligence models—for example, according to the principles described above. As shown in FIGS. 1-3, examples of the system 100 may be implemented with a user device 104 and a networked computing platform 108. As shown in FIG. 100, the system 100 may include a communications system 112. The user devices of the system 100—such as user device 104 and computing platform 108—may communicate via the communications system 112. Examples of the communications system 112 may include one or more networks, such as a General Packet Radio Service (GPRS) network, a Time-Division Multiple Access (TDMA) network, a Code-Division Multiple Access (CDMA) network, a Global System of Mobile Communications (GSM) network, an Enhanced Data Rates for GSM Evolution (EDGE) network, a High-Speed Packet Access (HSPA) network, an Evolved High-Speed Packet Access (HSPA+) network, a Long Term Evolution (LTE) network, a Worldwide Interoperability for Microwave Access (WiMAX) network, a 5th-generation mobile network (5G), an Internet Protocol (IP) network, a Wireless Application Protocol (WAP) network, or an IEEE 802.11 standards network, as well as any suitable combination of the above networks. In various implementations, the communications system 112 may also include an optical network, a local area network, and/or a global communication network, such as the Internet.

As shown in FIGS. 1-3, the user device 104 may include one or more integrated circuits suitable for performing the instructions and tasks involved in computer processing. For example, the user device 104 may include one or more processor(s) 116. The user device 104 may also include one or more electronic chipsets for managing data flow between components of the user device 104. For example, the user device 104 may include a platform controller hub 120. The user device 104 may also include one or more devices or system used to store information for immediate use by other components of the user device 104. For example, the user device 104 may include memory 124. In various implementations, memory 124 may include random-access memory (RAM)—such as non-volatile random-access memory (NVRAM), dynamic random-access memory (DRAM), and static random-access memory (SRAM). The user device 104 may also include a communications interface 128 suitable for communicating with other communications interfaces via the communications system 112. In various implementations, the communications interface 128 may include one or more transceivers suitable for sending and/or receiving data to and from other communications interfaces via the communications system 112.

The user device 104 may include a system suitable for generating a feed of graphics output to a display device. For example, the user device 104 may include a display adapter 132. In various implementations, the display adapter 132 may include one or more graphics processing units that can be used for additional computational processing. In various implementations, the graphics processing units of display adapter 132 may be used to reduce the computational load of the processor(s) 116. The user device 104 may also include one or more non-transitory computer-readable storage media—such as storage 136. In various implementations, storage 136 may include one or more hard disk drives (HDD), single-level cell (SLC) NAND flash, multi-level cell (MLC) NAND flash, triple-level cell (TLC) NAND flash, quad-level cell (QLC) NAND flash, NOR flash, or any other suitable non-volatile memory or non-volatile storage medium accessible by components of the user device 104. One or more software modules—such as web browser 164 and/or test module access application 168—may be stored on storage 136. Instructions of the software modules stored on storage 136 may be executed by the processor(s) 116 and/or display adapter 132.

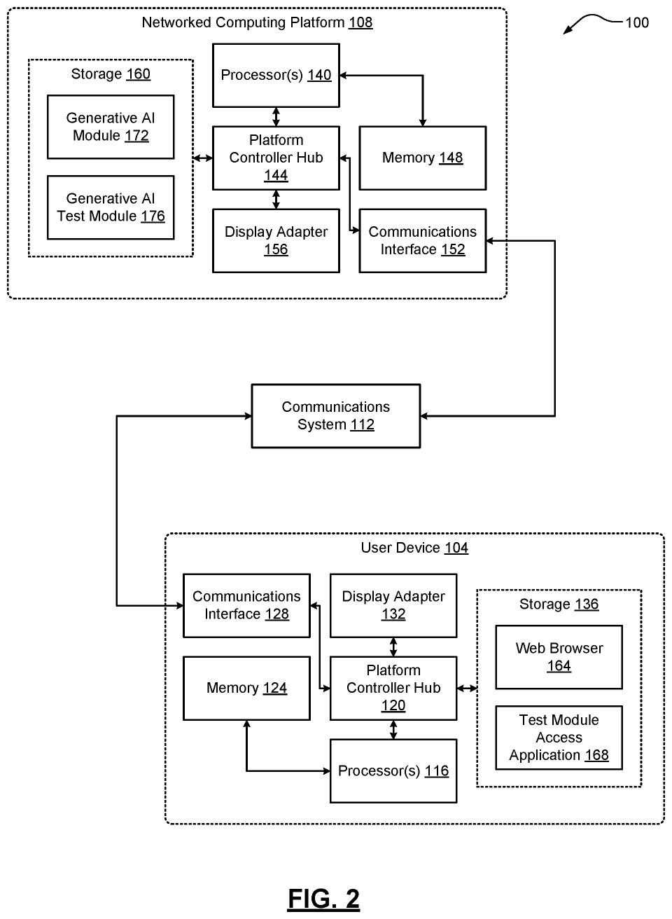

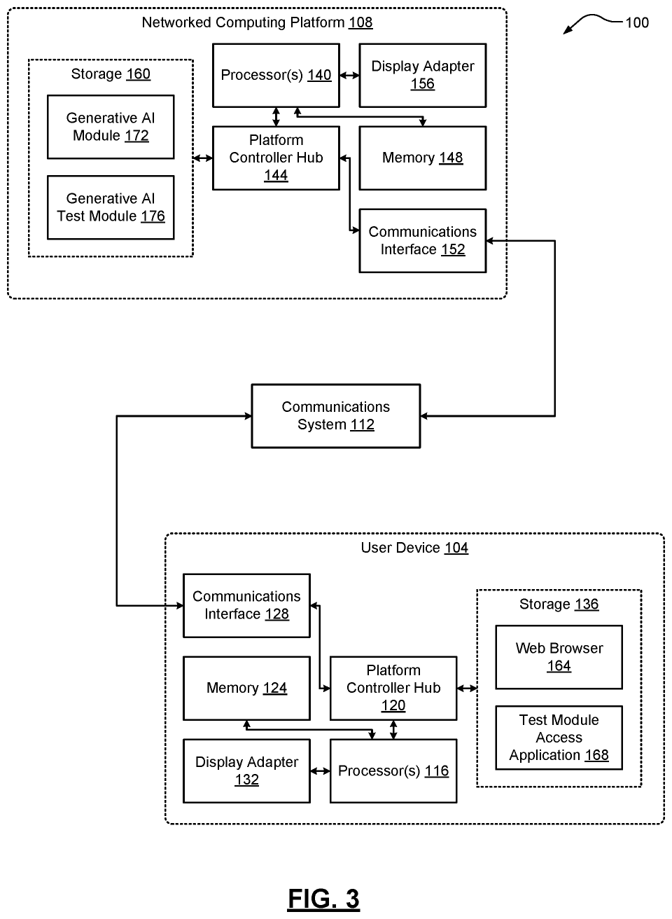

The processor(s) 116, platform controller hub 120, memory 124, communications interface 128, display adapter 132, and/or storage 136 may be operatively coupled to each other. As shown in FIG. 1, in some examples, the processor(s) 116, memory 124, communications interface 128, display adapter 132, and/or storage 136 may be operatively coupled to the platform controller hub 120. In the example of FIG. 1, the platform controller hub 120 functions as a traffic controller between each of the memory 124, communications interface 128, display adapter 132, and/or storage 136 and the processor(s) 116. As shown in FIG. 2, in some examples, the processor(s) 116, communications interface 128, display adapter 132, and/or storage 136 may be operatively coupled to the platform controller hub 120, while the memory 124 is operatively coupled to the processor(s) 116. In the example of FIG. 2, the platform controller hub 120 functions as a traffic controller between each of the communications interface 128, display adapter 132, and/or storage 136 and the processor(s) 116, while the processor(s) 116 may communicate directly with the memory 124. As shown in FIG. 3, in some examples, the processor(s) 116, communications interface 128, and/or storage 136 may be operatively coupled to the platform controller hub 120, while the memory 124 and/or the display adapter 132 are operatively coupled to the processor(s) 116. In the example of FIG. 3, the platform controller hub 120 functions as a traffic controller between each of the communications interface 128 and/or storage 136, while the processor(s) 116 may communicate directly with the memory 124 and/or the display adapter 132.

As shown in FIGS. 1-3, the networked computing platform 108 may include one or more integrated circuits suitable for performing the instructions and tasks involved in computer processing. For example, the networked computing platform 108 may include one or more processor(s) 140. The networked computing platform 108 may also include one or more electronic chipsets for managing data flow between components of the networked computing platform 108. For example, the networked computing platform 108 may include a platform controller hub 144. The networked computing platform 108 may also include one or more devices or system used to store information for immediate use by other components of the networked computing platform 108. For example, the networked computing platform 108 may include memory 148. In various implementations, memory 148 may include random-access memory (RAM)—such as non-volatile random-access memory (NVRAM), dynamic random-access memory (DRAM), and static random-access memory (SRAM). The networked computing platform 108 may also include a communications interface 152 suitable for communicating with other communications interfaces via the communications system 112. In various implementations, the communications interface 152 may include one or more transceivers suitable for sending and/or receiving data to and from other communications interfaces via the communications system 112.

The networked computing platform 108 may include a system suitable for generating a feed of graphics output to a display device. For example, the networked computing platform 108 may include a display adapter 156. In various implementations, the display adapter 156 may include one or more graphics processing units that can be used for additional computational processing. In various implementations, the graphics processing units of display adapter 156 may be used to reduce the computational load of the processor(s) 140. The networked computing platform 108 may also include one or more non-transitory computer-readable storage media—such as storage 160. In various implementations, storage 160 may include one or more hard disk drives (HDD), single-level cell (SLC) NAND flash, multi-level cell (MLC) NAND flash, triple-level cell (TLC) NAND flash, quad-level cell (QLC) NAND flash, NOR flash, or any other suitable non-volatile memory or non-volatile storage medium accessible by components of the networked computing platform 108. One or more software modules—such as generative artificial intelligence module 172 and/or generative artificial intelligence test module 176—may be stored on storage 160. Instructions of the software modules stored on storage 160 may be executed by the processor(s) 140 and/or display adapter 156.

The processor(s) 140, platform controller hub 144, memory 148, communications interface 152, display adapter 156, and/or storage 160 may be operatively coupled to each other. As shown in FIG. 1, in some examples, the processor(s) 140, memory 148, communications interface 152, display adapter 156, and/or storage 160 may be operatively coupled to the platform controller hub 144. In the example of FIG. 1, the platform controller hub 144 functions as a traffic controller between each of the memory 148, communications interface 152, display adapter 156, and/or storage 160 and the processor(s) 140. As shown in FIG. 2, in some examples, the processor(s) 140, communications interface 152, display adapter 156, and/or storage 160 may be operatively coupled to the platform controller hub 144, while the memory 148 is operatively coupled to the processor(s) 140. In the example of FIG. 2, the platform controller hub 144 functions as a traffic controller between each of the communications interface 152, display adapter 156, and/or storage 160 and the processor(s) 140, while the processor(s) 140 may communicate directly with the memory 148. As shown in FIG. 3, in some examples, the processor(s) 140, communications interface 152, and/or storage 160 may be operatively coupled to the platform controller hub 144, while the memory 148 and/or the display adapter 156 are operatively coupled to the processor(s) 140. In the example of FIG. 3, the platform controller hub 144 functions as a traffic controller between each of the communications interface 152 and/or storage 160, while the processor(s) 140 may communicate directly with the memory 148 and/or the display adapter 156.

In various implementations, components of the user device 104 may communicate with components of the networked computing platform 108 via the communications system 112. For example, components of the user device 104 may communicate with the communications interface 128, and components of the networked computing platform 108 may communicate with communications interface 152. Communications interface 128 and communications interface 152 may then communicate with each other via the communications system 112.

### Flowcharts

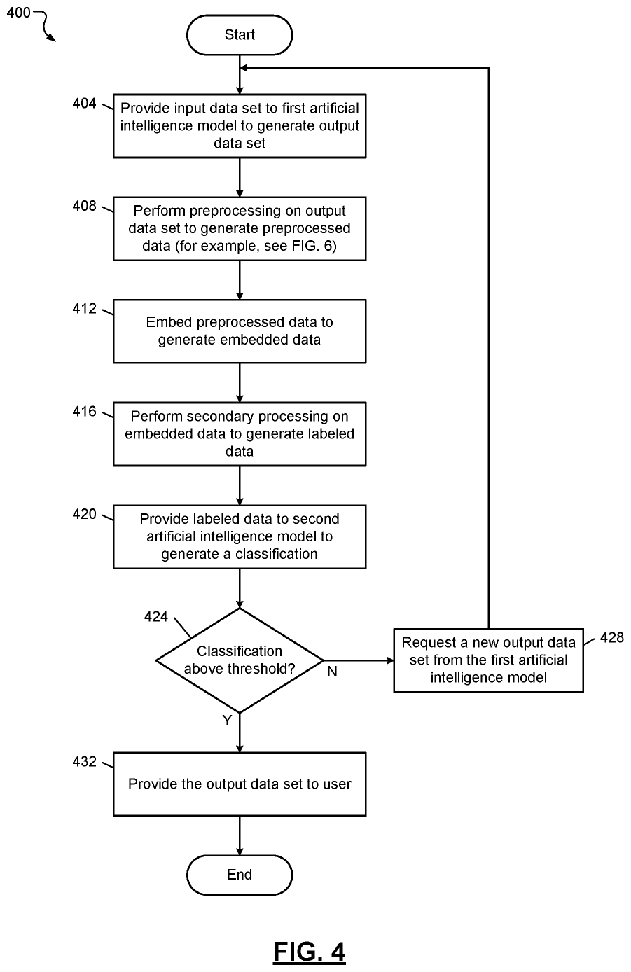

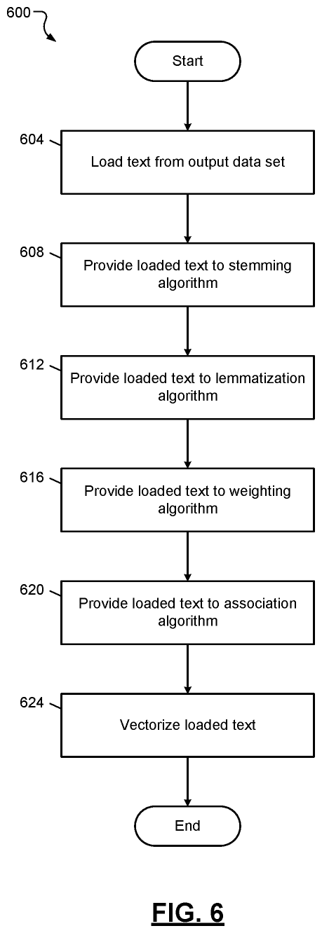

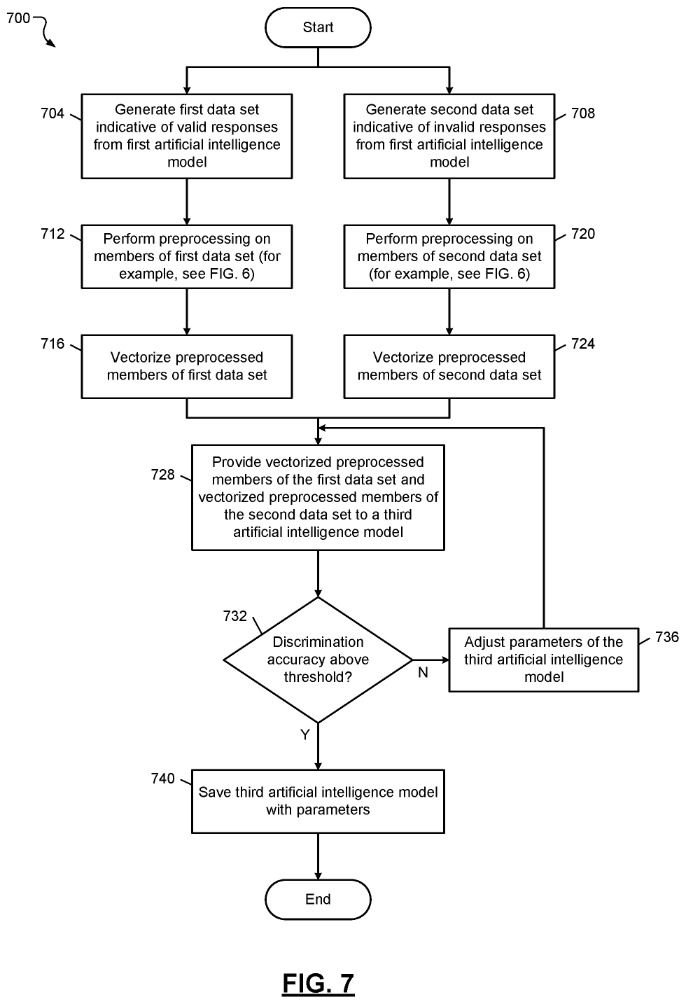

FIG. 4 is a flowchart of an example process 400 for evaluating artificial intelligence models. The example process 400 may begin in response to a user inputting a request into web browser 164 and/or test module access application 168 (at block 404). The web browser 164 and/or test module access application 168 may send a request to generative artificial intelligence module 172 for the generative artificial intelligence module 172 to generate an output data set. In various implementations, the generative artificial intelligence module 172 may be include a first artificial intelligence model—such as a large language model—and the output data set may include one or more sequences of text. In the example process 400, the generative artificial intelligence module 172 provides the output data set to the generative artificial intelligence test module 176, and the generative artificial intelligence test module 176 performs preprocessing on the output data set to generate preprocessed data (at block 408). Additional details of generating preprocessed data at 408 will be described further on in this specification with reference to FIG. 6.

In the example process 400, the generative artificial intelligence test module 176 embeds the preprocessed data to generate embedded data (at block 412). In various implementations, the generative artificial intelligence test module 176 may generate one or more graphs based on the processed data. As previously described, the embedded data may include graphs with (i) nodes indicating terms from the output data and (ii) edges or links between the nodes indicating relationships between the nodes. In various implementations, the edges or links may be generated according to association-based graph machine learning techniques. In various implementations, subnetworks of the embedded data may include nodes connected with edges and be indicative of statements. In some examples, edge weightings may be computed based on node or neighborhood properties. For example, edge weightings may be computed based on the utility difference between nodes and/or an average neighborhood utility within n hops of a node (where n can be any specified number). In utility difference techniques, a measure of utility (such as a measure of importance, centrality, and/or other relevant metric) can be computed for each node and the edge weight can be computed based on a difference in utility between the two nodes the edge connects. In average neighborhood utility techniques, an average utility of neighboring nodes (for example, within n hops from a given node) is computed, and edge weights can be determined based on how the utility of the nodes at either end of an edge compares to an average utility of the neighboring nodes of the nodes at either end.

In the example process 400, the generative artificial intelligence test module 176 may perform secondary processing on the embedded data (at block 416). In various implementations, the secondary processing may include graph techniques—such as graph mining techniques-used to identify problematic results based on the embedded data. In various implementations, the secondary processing may produce a labeled set with labels indicating whether responses or portions of responses from the first artificial intelligence model are valid or invalid. In various implementations, subnetworks of the embedded data may be evaluated. For example, subnetworks may be evaluated based on their proximity and associations with other subnetworks.

In the example process 400, the generative artificial intelligence test module 176 may provide the labeled data to a second artificial intelligence model to generate a classification (at block 420). In various implementations, the second artificial intelligence model may be a binary classification model that receives the labeled data and generates a classification. In the example process 400, the generative artificial intelligence test module 176 determines whether the classification is above a threshold (at decision block 424). In response to the classification not being above the threshold (“NO” at decision block 424), the classification may indicate that the output data set from the first artificial intelligence model is not valid and the generative artificial intelligence test module 176 requests a new output data set from the first artificial intelligence model (at block 428) and the example process 400 proceeds back to block 404. In response to the classification being above the threshold (“YES” at decision block 424), then the classification may indicate that the output data set from the first artificial intelligence model is valid and the generative artificial intelligence test module 176 provides the output data set to the user at 432. In various implementations, the generative artificial intelligence test module 176 provides the output data set to the web browser 164, and the web browser 164 transforms a graphical user interface to display the output data set to the user. In various implementations, the generative artificial intelligence test module 176 provides the output data set to the test module access application 168, and the test module access application 168 transforms a graphical user interface to display the output data set to the user.

In various implementations, the artificial intelligence test module 176 may continuously execute the process 400 and compare the classification generated at block 424 against multiple thresholds. The artificial intelligence test module 176 may take a different action (at block 428) for each comparison (to a different threshold). For example, the artificial intelligence test module 176 may increase thoroughness requirements for human review in response to one comparison, require attestation in response to a different comparison, etc.

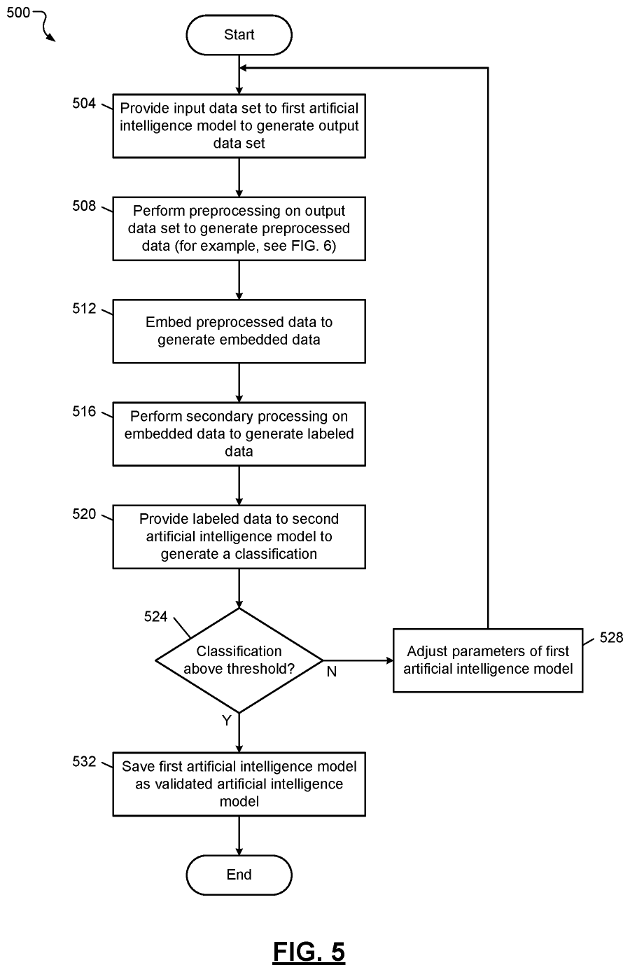

FIG. 5 is a flowchart of an example process 500 for evaluating artificial intelligence models. For example, the example process 500 may begin in response to a user inputting a request into web browser 164 and/or test module access application 168 (at block 504). The web browser 164 and/or test module access application 168 may send a request to generative artificial intelligence module 172 for the generative artificial intelligence module 172 to generate an output data set. In various implementations, the generative artificial intelligence module 172 may include a first artificial intelligence model—such as a large language model—and the output data set may include one or more sequences of text. In the example process 500, the generative artificial intelligence module 172 provides the output data set to the generative artificial intelligence test module 176, and the generative artificial intelligence test module 176 performs preprocessing on the output data set to generate preprocessed data (at block 508). Additional details of generating preprocessed data at block 508 will be described further on in this specification with reference to FIG. 6.

In the example process 500, the generative artificial intelligence test module 176 embeds the preprocessed data to generate embedded data (at block 512). In various implementations, the generative artificial intelligence test module 176 may generate one or more graphs based on the processed data. As previously described, the embedded data may include graphs with nodes indicating terms from the output data and edges or links between the nodes indicating relationships between the nodes. In various implementations, the edges or links may be generated according to association-based graph machine learning techniques. In various implementations, subnetworks of the embedded data may include nodes connected with edges and be indicative of statements. In some examples, edge weightings may be computed based on node or neighborhood properties. For example, edge weightings may be computed based on the utility difference between nodes and/or an average neighborhood utility within n hops of a node (where n can be any specified number). In utility difference techniques, a measure of utility (such as a measure of importance, centrality, and/or other relevant metric) can be computed for each node and the edge weight can be computed based on a difference in utility between the two nodes the edge connects. In average neighborhood utility techniques, an average utility of neighboring nodes (for example, within n hops from a given node) is computed, and edge weights can be determined based on how the utility of the nodes at either end of an edge compares to an average utility of the neighboring nodes of the nodes at either end.

In the example process 500, the generative artificial intelligence test module 176 may perform secondary processing on the embedded data (at block 516). In various implementations, the secondary processing may include graph techniques—such as graph mining techniques—used to identify problematic results based on the embedded data. In various implementations, the secondary processing may produce a labeled set with labels indicating whether responses or portions of responses from the first artificial intelligence model are valid or invalid. In various implementations, subnetworks of the embedded data may be evaluated. For example, subnetworks may be evaluated based on their proximity and associations with other subnetworks.

In the example process 500, the generative artificial intelligence test module 176 may provide the labeled data to a second artificial intelligence model to generate a classification (at block 520). In various implementations, the second artificial intelligence model may be a binary classification model that receives the labeled data and generates a classification. In the example process 500, the generative artificial intelligence test module 176 determines whether the classification is above a threshold (at decision block 524). In response to the classification not being above the threshold (“NO” at decision block 524), the classification may indicate that the output data set from the first artificial intelligence model is not valid and the generative artificial intelligence test module 176 adjusts parameters of the first artificial intelligence module (at block 528) and generative artificial intelligence module 172 again provides an input data set to the first artificial intelligence model to generate an output data set (at block 504). In response to the classification being above the threshold (“YES” at decision block 524), the classification may indicate that the output data set from the first artificial intelligence model is valid and the generative artificial intelligence test module 176 saves the first artificial intelligence model as a validated artificial intelligence model (at block 532). In the example process 500, after the generative artificial intelligence test module 176 adjusts parameters of the first artificial intelligence module (at block 528), the example process 500 proceeds back to block 504.

FIG. 6 is a flowchart of an example process 600 for performing preprocessing on output data sets from artificial intelligence models. In the example process 600, the generative artificial intelligence test module 176 loads text from an output data set (at block 604). In various implementations, the output data set may include the output data set generated by the first artificial intelligence model at 404 of FIG. 4 or 504 of FIG. 5, members of the first data set generated at 704 of FIG. 7, and/or members of the second data set generated at 708 of FIG. 7. In the example process 600, the generative artificial intelligence test module 176 provides the loaded text to a stemming algorithm (at block 608). In various implementations, the stemming algorithm reduces all words with the same root or stem to a common form. For example, the stemming algorithm may remove derivational and/or inflectional suffixes from each word. In the example process 600, the generative artificial intelligence test module 176 provides the loaded text to a lemmatization algorithm (at block 612). In various implementations, the lemmatization algorithm may reduce each word to its root. In the example process 600, the generative artificial intelligence test module 176 provides the loaded text to a weighting algorithm (at block 616). In the example process 600, the generative artificial intelligence test module 176 provides the loaded text to an association algorithm (at block 620). In various implementations, the association algorithm may include an n-gram language model. In the example process 600, the generative artificial intelligence test module 176 vectorizes the loaded text (at block 624). In various implementations, the generative artificial intelligence test module 176 may vectorize the loaded text after it has been processed at one or more of blocks 608-620.

FIG. 7 is a flowchart of an example process 700 for evaluating and retraining artificial intelligence models. In various implementations, the example process 700 begins at blocks 704 and 708. For example, in the example process 700, the generative artificial intelligence test module 176 calls on the generative artificial intelligence module 172 to generate a first data set from a first artificial intelligence module (at block 704). In various implementations, the first artificial intelligence module may include a large language model. In various implementations, the first data set may be indicative of and/or include valid responses from the first artificial intelligence model. In the example process 700, the generative artificial intelligence test module 176 calls on the generative artificial intelligence module 172 to generate a second data set from the first artificial intelligence module (at block 708). In various implementations, the second data set may be indicative of and/or include invalid responses from the first artificial intelligence model. From block 704, the example process 700 proceeds to block 712. In the example process s700, the generative artificial intelligence test module 176 performs preprocessing on members of the first data set (at block 712). For example, the generative artificial intelligence test module 176 may perform preprocessing according to processes previously described with reference to FIG. 6. In the example process 700, the generative artificial intelligence test module 176 vectorizes preprocessed members of the first data set (at block 716). In the example process 700, after the generative artificial intelligence test module 176 vectorizes preprocessed members of the first data set (at block 716), the generative artificial intelligence test module 176 provides the vectorized preprocessed members of the first data set and the vectorized preprocessed members of the second data set to a third artificial intelligence model (at block 728).

In the example process 700, after generative artificial intelligence test module 176 calls on the generative artificial intelligence module 172 to generate a second data set from the first artificial intelligence module (at block 708), the generative artificial intelligence test module 176 performs preprocessing on members of the second data set (at block 720). For example, generative artificial intelligence test module 176 may perform preprocessing according to processes previously described with reference to FIG. 6. In the example process 700, the generative artificial intelligence test module 176 vectorizes preprocessed members of the second data set (at block 724). In the example process 700, after the generative artificial intelligence test module 176 vectorizes preprocessed members of the second data set (at block 724), the generative artificial intelligence test module 176 provides the vectorized preprocessed members of the first data set and the vectorized preprocessed members of the second data set to a third artificial intelligence model (at block 728). In various implementations, the third artificial intelligence model may be a neural network configured to discriminate between vectors indicative of valid responses from the first artificial intelligence model and invalid responses from the first artificial intelligence model.

In the example process 700, the generative artificial intelligence test module 176 determines whether the discrimination accuracy of the third artificial intelligence model is above a threshold (at decision block 732). In response to the discrimination accuracy of the third artificial intelligence model not being above the threshold (“NO” at decision block 732), the generative artificial intelligence test module 176 adjusts parameters of the third artificial intelligence model (at block 736) and generative artificial intelligence test module 176 again provides the vectorized preprocessed members of the first data set and the vectorized preprocessed members of the second data set to a third artificial intelligence model (at block 728). In response to the discrimination accuracy of the third artificial intelligence model being above the threshold (“YES” at decision block 732), the generative artificial intelligence test module 176 saves the third artificial intelligence model with the current configuration of parameters (at block 740).

### Machine Learning Models

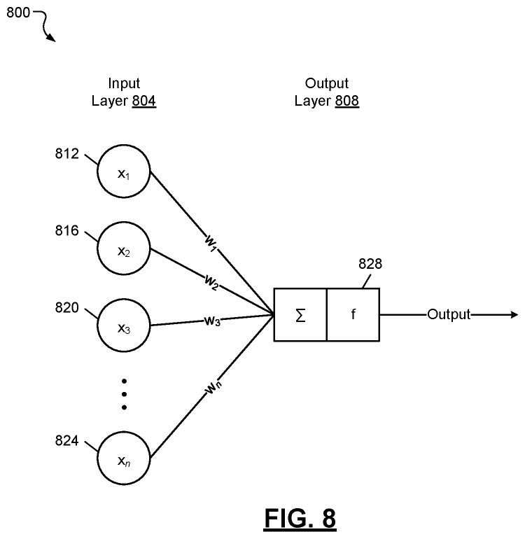

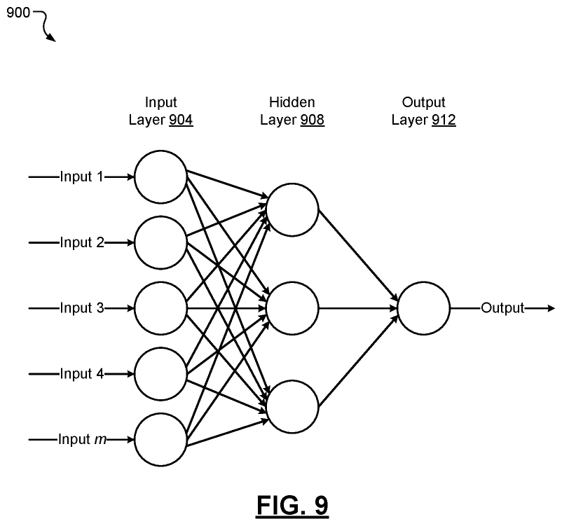

FIG. 8 is a graphical representation of an example neural network with no hidden layers. Any of the previously described artificial intelligence models or machine learning models may be implemented as a neural network in accordance with the principles described with reference to FIGS. 8 and 9. Generally, neural networks may include an input layer, an output layer, and any number-including none—of hidden layers between the input layer and the output layer. Each layer of the machine learning model may include one or more nodes with each node representing a scalar. Input variables may be provided to the input layer. Any hidden layers and/or the output layer may transform the inputs into output variables, which may then be output from the neural network at the output layer. In various implementations, the input variables to the neural network may be an input vector having dimensions equal to the number of nodes in the input layer. In various implementations, the output variables of the neural network may be an output vector having dimensions equal to the number of nodes in the output layer.

Generally, the number of hidden layers—and the number of nodes in each layer—may be selected based on the complexity of the input data, time complexity requirements, and accuracy requirements. Time complexity may refer to an amount of time required for the neural network to learn a problem—which can be represented by the input variables—and produce acceptable results—which can be represented by the output variables. Accuracy may refer to how close the results represented by the output variables are to real results. In various implementations, increasing the number of hidden layers and/or increasing the number of nodes in each layer may increase the accuracy of neural networks but also increase the time complexity. Conversely, in various implementations, decreasing the number of hidden layers and/or decreasing the number of nodes in each layer may decrease the accuracy of neural networks but also decrease the time complexity.

As shown in FIG. 8, some examples of neural networks, such as neural network 800, may have no hidden layers. Neural networks with no hidden layers may be suitable for solving problems with input variables that represent linearly separable data. For example, if data can be represented by sets of points existing in a Euclidean plane, then the data may be considered linearly separable if the sets of points can be divided by a single line in the plane. If the data can be represented by sets of points existing in higher-dimensional Euclidean spaces, the data may be considered linearly separable if the sets can be divided by a single plane or hyperplane. Thus, in various implementations, the neural network 800 may function as a linear classifier and may be suitable for performing linearly separable decisions or functions.

As shown in FIG. 8, the neural network 800 may include an input layer—such as input layer 804, an output layer—such as output layer 808, and no hidden layers. Data may flow forward in the neural network 800 from the input layer 804 to the output layer 808, and the neural network 800 may be referred to as a feedforward neural network. Feedforward neural networks having no hidden layers may be referred to as single-layer perceptrons. In various implementations, the input layer 804 may include one or more nodes, such as nodes 812-824. Although only four nodes are shown in FIG. 8, the input layer 804 may include any number of nodes, such as n nodes. In various implementations, each node of the input layer 804 may be assigned any numerical value. For example, node 812 may be assigned a scalar represented by x₁, node 816 may be assigned a scalar represented by x₂, node 820 may be assigned a scalar represented by x₃, and node 824 may be assigned a scalar represented by xₙ.

In various implementations, each of the nodes 812-824 may correspond to an element of the input vector. For example, the input variables to a neural network may be expressed as input vector i having n dimensions. So for neural network 800—which has an input layer 804 with nodes 812-824 assigned scalar values x₁-xₙ, respectively-input vector i may be represented by equation (1) below:

$$i = 〈 {x}_{1} , {x}_{2} , {x}_{3} , {x}_{n} 〉 . \qquad ( 1 )$$

In various implementations, input vector i may be a signed vector, and each element may be a scalar value in a range of between about −1 and about 1. So, in some examples, the ranges of the scalar values of nodes 112-124 may be expressed in interval notation as: x₁∈[−1,1], x₂∈[−1,1], x₃∈[−1,1], and xₙ∈[−1,1].

Each of the nodes of a previous layer of a feedforward neural network—such as neural network 800—may be multiplied by a weight before being fed into one or more nodes of a next layer. For example, the nodes of the input layer 804 may be multiplied by weights before being fed into one or more nodes of the output layer 808. In various implementations, the output layer 808 may include one or more nodes, such as node 828. While only a single node is shown in FIG. 8, the output layer 808 may have any number of nodes. In the example of FIG. 8, node 812 may be multiplied by a weight w/before being fed into node 828, node 816 may be multiplied by a weight w₂ before being fed into node 828, node 820 may be multiplied by a weight w₃ before being fed into node 828, and node 824 may be multiplied by a weight wₙ before being fed into node 828. At each node of the next layer, the inputs from the previous layer may be summed, and a bias may be added to the sum before the summation is fed into an activation function. The output of the activation function may be the output of the node.

In various implementations—such as in the example of FIG. 8, the summation of inputs from the previous layer may be represented by Σ. In various implementations, if a bias is not added to the summed outputs of the previous layer, then the summation Σ may be represented by equation (2) below:

$$\sum = {x}_{1} {w}_{1} + {x}_{2} {w}_{2} + {x}_{3} {w}_{3} + {x}_{n} {w}_{n} . \qquad ( 2 )$$

In various implementations, if a bias b is added to the summed outputs of the previous layer, then summation Σ may be represented by equation (3) below:

$$\sum = {x}_{1} {w}_{1} + {x}_{2} {w}_{2} + {x}_{3} {w}_{3} + {x}_{n} {w}_{n} + b . \qquad ( 3 )$$

The summation Σ may then be fed into activation function ƒ. In various implementations, the activation function ƒ may be any mathematical function suitable for calculating an output of the node. Example activation functions ƒ may include linear or non-linear functions, step functions such as the Heaviside step function, derivative or differential functions, monotonic functions, sigmoid or logistic activation functions, rectified linear unit (ReLU) functions, and/or leaky ReLU functions. The output of the function ƒ may then be the output of the node. In a neural network with no hidden layers—such as the single-layer perceptron shown in FIG. 8—the output of the nodes in the output layer may be the output variables or output vector of the neural network. In the example of FIG. 8, the output of node 828 may be represented by equation (4) below if the bias b is not added, or equation (5) below if the bias b is added:

$$Output = f ( {x}_{1} {w}_{1} + {x}_{2} {w}_{2} + {x}_{3} {w}_{3} + {x}_{n} {w}_{n} ) , and \qquad ( 4 )$$

$$Output = f ( {x}_{1} {w}_{1} + {x}_{2} {w}_{2} + {x}_{3} {w}_{3} + {x}_{n} {w}_{n} + b ) . \qquad ( 5 )$$

Thus, as neural network 800 is illustrated in FIG. 8 with an output layer 808 having only a single node 828, the output vector of neural network 800 is a one-dimensional vector (e.g., a scalar). However, as the output layer 808 may have any number of nodes, the output vector may have any number of dimensions.

FIG. 9 is a graphical representation of an example neural network with one hidden layer. Neural networks with one hidden layer may be suitable for performing continuous mapping from one finite space to another. Neural networks having two hidden layers may be suitable for approximating any smooth mapping to any level of accuracy. As shown in FIG. 9, the neural network 900 may include an input layer—such as input layer 904, a hidden layer—such as hidden layer 908, and an output layer—such as output layer 912. In the example of FIG. 9, each node of a previous layer of neural network 900 may be connected to each node of a next layer. So, for example, each node of the input layer 904 may be connected to each node of the hidden layer 908, and each node of the hidden layer 908 may be connected to each node of the output layer 912. Thus, the neural network shown in FIG. 9 may be referred to as a fully-connected neural network. However, while neural network 900 is shown as a fully-connected neural network, each node of a previous layer does not necessarily need to be connected to each node of a next layer. A feedforward neural network having at least one hidden layer—such as neural network 900—may be referred to as a multilayer perceptron.

In a manner analogous to neural networks described with reference to FIG. 8, input vectors for neural network 900 may be m-dimensional vectors, where m is a number of nodes in input layer 904. Each element of the input vector may be fed into a corresponding node of the input layer 904. Each node of the input layer 904 may then be assigned a scalar value corresponding to the respective element of the input vector. Each node of the input layer 904 may then feed its assigned scalar value—after it is multiplied by a weight—to one or more nodes of the next layer, such as hidden layer 908. Each node of hidden layer 908 may take a summation of its inputs (e.g., a weighted summation of the nodes of the input layer 904) and feed the summation into an activation function. In various implementations, a bias may be added to the summation before it is fed into the activation function. In various implementations, the output of each node of the hidden layer 908 may be calculated in a manner similar or analogous to that described with respect to the output of node 828 of FIG. 8.

Each node of the hidden layer 908 may then feed its output—after it is multiplied by a weight—to one or more nodes of the next layer, such as output layer 912. Each node of the output layer 912 may take a summation of its inputs (e.g., a weighted summation of the outputs of the nodes of hidden layer 908) and feed the summation into an activation function. In various implementations, a bias may be added to the summation before it is fed into the activation function. In various implementations, the output of each node of the output layer 912 may be calculated in a manner similar or analogous to that described with respect to the output of node 828 of FIG. 8. The output of the nodes of the output layer 912 may be the output variables or the output vector of neural network 900. While only a single hidden layer is shown in FIG. 9, neural network 900 may include any number of hidden layers. A weighted summation of the outputs of each previous hidden layer may be fed into nodes of the next hidden layer, and a weighted summation of the outputs of those nodes may be fed into a further hidden layer. A weighted summation of the outputs of a last hidden layer may be fed into nodes of the output layer.

### Additional Flowcharts

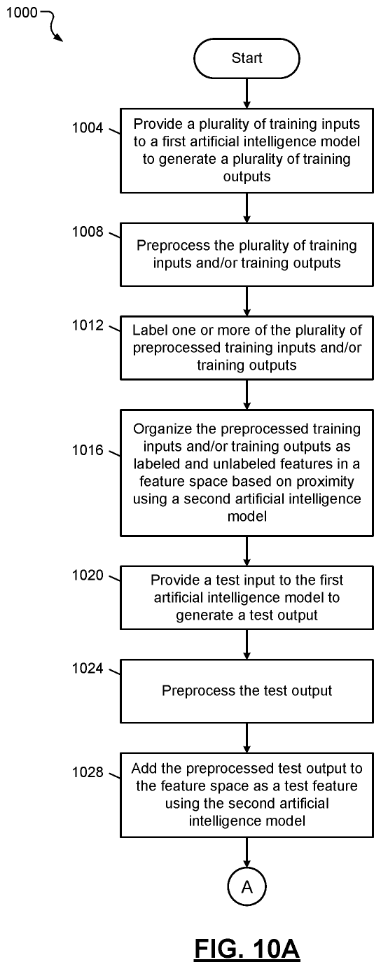

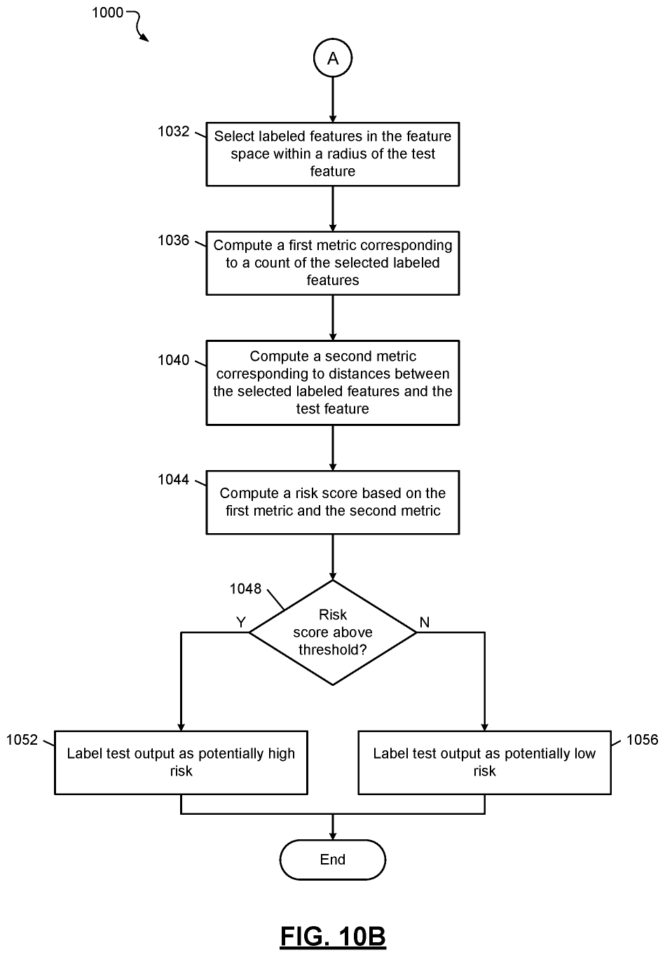

FIGS. 10A-10B are flowcharts of an example process 1000 for evaluating artificial intelligence models. In the example process 1000, generative artificial intelligence test module 176 provides a plurality of training inputs to a first artificial intelligence model—such as a large language model—at generative artificial intelligence module 172 to generate plurality of training outputs (at block 1004). In some embodiments, each of the plurality of training inputs includes one or more text strings and each of the plurality of training outputs includes one or more text strings. In the example process 1000, generative artificial intelligence test module 176 preprocesses the plurality of training inputs and/or training outputs (at block 1008). For example, the generative artificial intelligence test module 176 performs stemming, lemmatization, stop word removal, part-of-speech tagging, and tokenization operations on the plurality of training inputs and/or training outputs. In various implementations, generative artificial intelligence test module 176 performs preprocessing operations as previously discussed with reference to FIG. 6.

In the example process 1000, the generative artificial intelligence test module 176 labels one or more of the plurality of preprocessed training inputs and/or preprocessed training outputs (at block 1012). In some embodiments, generative artificial intelligence test module 176 applies a first label to each preprocessed training input and/or preprocessed training output that contains certain terms (such as terms on a banned word list). In some examples, the generative artificial intelligence test module 176 applies a second label to each preprocessed training input and/or preprocessed training output that has been marked as problematic by users. In various implementations, the generative artificial intelligence test module 176 applies a third label to each preprocessed training input and/or preprocessed training output that are designed to conform to a one or more criteria (for example, to be offensive and/or insulting).

In the example process 1000, generative artificial intelligence test module 176 organizes the preprocessed training inputs and/or training outputs as labeled and unlabeled features in a feature space based on proximity using a second artificial intelligence model (at block 1016). For example, generative artificial intelligence test module 176 generates a graph with each of the labeled and unlabeled features as nodes on the graph. Each of the nodes may be positioned so that nodes corresponding to training inputs and/or training outputs having more similar text are positioned closer together while nodes corresponding to training inputs and/or training outputs having more dissimilar text are position further apart. In some examples, the proximity between nodes may be measured in terms of units of a feature space.

The feature space may be formed by the attributes that characterize each node and/or link. For example, relevant attributes characterizing the nodes may include textual features (such as lengths of utterances, word count, and/or frequency of words), semantic features (such as embeddings representing the semantic content of utterances), syntactic features (such as attributes derived from the structure of the utterances), sentiment features (such as the tone of the utterances), topic features, etc. Relevant attributes characterizing the links may include the sequential relation between utterances, the semantic similarity between utterances, referential features (for example, attributes indicating whether one utterance refers to the same subject or object as another), response quality (for example, indicating the relevance of one utterance in response to another), transition patterns (for example, indicating how topics or sentiments transition from one utterance to the next), etc.

In various implementations, the feature space is multi-dimensional and the proximity between two nodes may be represented as a vector between two nodes (or a matrix in examples where the proximity is between multiple nodes). Representing the proximity as a vector or a matrix offers a variety of technical benefits over techniques where the proximity is represented as a scalar. For example, elements of a vector or matrix can be weighted to produce a more complex and/or conditional assessment of proximity. In some examples, a single multi-dimensional feature space may be used for multiple purposes (e.g., different evaluation criteria). For example, a different vector (or matrix) weighting map can be generated for each application (e.g., each set of evaluation criteria). Since the same feature space can be shared across multiple purposes/applications, these techniques save computing resources as they do not require a unique feature space to be generated for each application.

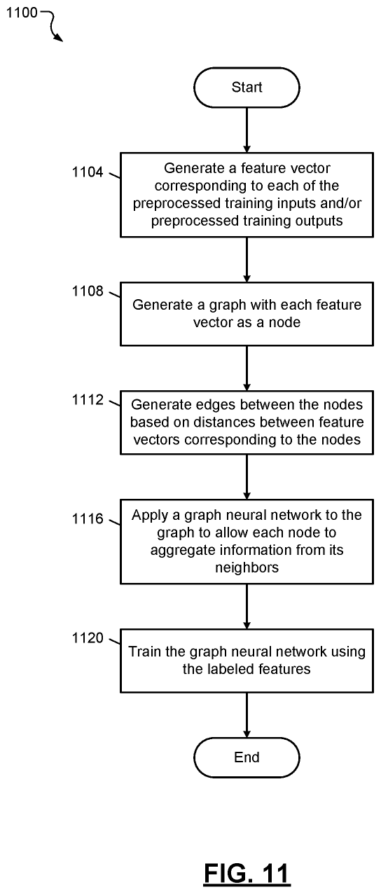

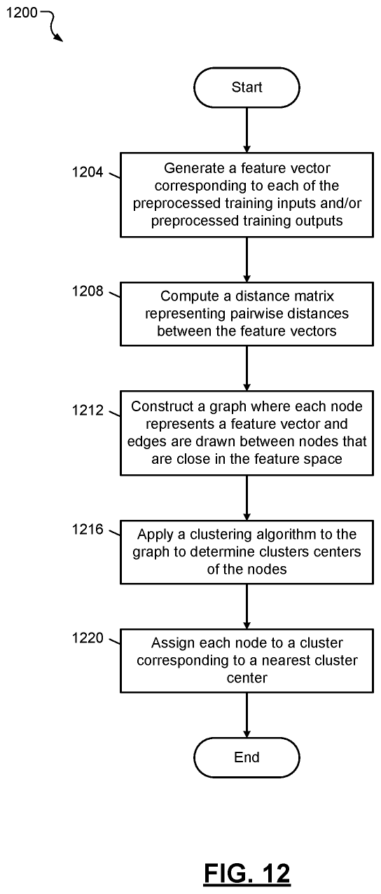

In various implementations, the second artificial intelligence model includes a graph neural network—such as a latent graph neural network. Additional details associated with organizing the preprocessed training inputs and/or training outputs as labeled and unlabeled features in the feature space based on proximity using the graph neural network will be described further on in this specification with reference to FIG. 11. In some embodiments, the second artificial intelligence model applies a topological clustering technique—such as the Coherent Point Drift (CPD) technique. Additional details associated with organizing the preprocessed training inputs and/or training outputs as labeled and unlabeled features in the feature space based on proximity using the topological clustering technique will be described further on in this specification with reference to FIG. 12.

In the example process 1000, the user provides a test input to the first artificial intelligence model at generative artificial intelligence module 172 (for example, as previously described with reference to FIG. 4) to generate a test output (at block 1020). In the example process 1000, the generative artificial intelligence test module 176 preprocesses the test output (at block 1024). For example, the generative artificial intelligence test module 176 preprocesses the test output according to the same techniques performed at block 1008. In the example process 1000, the generative artificial intelligence test module 176 adds the preprocessed test output to the feature space as a test feature (node) using the second artificial intelligence model (at block 1028). In the example process 1000, the generative artificial intelligence test module 176 selects labeled features in the feature space that are positioned within a defined radius of the test feature (at block 1032). In the example process 1000, the generative artificial intelligence test module 176 computes a first metric corresponding to a count of the selected labeled features (at block 1036). In the example process 1000, the generative artificial intelligence test module 176 computes a second metric corresponding to distances between the selected labeled features and the test feature (at block 1040). In some embodiments, the second metric may be computed as a Manhattan distance (or the distance measure representing the sum of distances between the test feature and each selected label feature).

In the example process 1000, the generative artificial intelligence test module 176 computes a risk score based on the first metric and the second metric (at block 1044). In the example process 1000, the generative artificial intelligence test module 176 determines whether the risk score is above a threshold (at decision block 1048). In response to determining that the risk score is above the threshold (“YES” at decision block 1048), the generative artificial intelligence test module 176 labels the test output as potentially high risk or erroneous (at block 1052). In response to determining that the risk score is not above the threshold (“NO” at decision block 1048), the generative artificial intelligence test module 176 labels the test output as potentially low risk or non-erroneous (at block 1056).

FIG. 11 is a flowchart of an example process 1100 for organizing preprocessed training inputs and/or outputs in a feature space based on proximity using a graph neural network. In the example process 1100, the generative artificial intelligence test module 176 generates a feature vector corresponding to each of the preprocessed training inputs and/or preprocessed training outputs to represent the text of the preprocessed training inputs and/or preprocessed training outputs in a numerical format (at block 1104). For example, techniques such as Term Frequency-Inverse Document Frequency (TF-IDF), Bag of Words (BoW), or methods like Word2Vec and GloVe, or transformers such as Bidirectional Encoder Representations from Transformers (BERT) or Generative Pre-training Transformers (GPT) can be used. These techniques transform text into numerical vectors in a high-dimensional space, which preserves semantic relationships between words.

In the example process 1100, generative artificial intelligence test module 176 generates a graph with each feature vector represented as a node (at block 1108). Thus, each node may represent one of the preprocessed training inputs and/or preprocessed training outputs. In the example process 1100, generative artificial intelligence test module 176 generates edges between the nodes based on distances between the feature vectors corresponding to the nodes (at block 1112). For example, edges can be generated based on the cosine similarities between feature vectors. In some embodiments, edges can be generated between each node and its k-nearest neighbors in the feature space. In the example process 1100, the generative artificial intelligence test module 176 applies the graph neural network to the graph to allow each node to aggregate information from its neighbors (at block 1116). In the example process 1100, the generative artificial intelligence test module 176 trains the graph neural network using the labeled features (at block 1120). For example, the graph neural network is trained to minimize the difference between its predicted and actual labels for the features. After the graph neural network is trained, new text inputs and/or outputs (for example, from the first artificial intelligence model) may be vectorized and added to the feature space as a new feature, and the graph neural network may be used to generate a label for the new feature.

FIG. 12 is a flowchart of an example process 1200 for organizing preprocessed training inputs and/or outputs in a feature space based on proximity using a topological clustering technique. In the example process 1200, the generative artificial intelligence test module 176 generates a feature vector corresponding to each of the preprocessed training inputs and/or preprocessed training outputs (at block 1204). For example, the generative artificial intelligence module 176 generates the feature vector according to any of the previously described techniques. In the example process 1200, the generative artificial intelligence test module 176 computes a distance matrix representing pairwise distances between the feature vectors (at block 1208). In various implementations, distances are calculated using Euclidean distance. In some embodiments, distances are calculated using cosine similarity. In some examples, distances are calculated as Manhattan distances, Hamming distances, Minkowski distances, Jaccard distances, Mahalanobis distances, or other suitable distances.

In the example process 1200, generative artificial intelligence test module 176 constructs a graph where each node represents a feature vector (at block 1212). Edges are drawn between nodes that are close in the feature space represented by the graph. For example, edges can be generated based on the cosine similarities between feature vectors. In some embodiments, edges can be generated between each node and its k-nearest neighbors in the feature space. In various implementations, weightings are added to the edges (for example, based on node and/or neighborhood properties as previously described). In the example process 1200, the generative artificial intelligence test module 176 applies a clustering algorithm to the graph to determine cluster centers of the nodes (at block 1216). For example, the CPD algorithm may be used to identify cluster centers. In the example process 1200, generative artificial intelligence test module 176 assigns each node to a cluster (at block 1220). For example, each node may be assigned to the cluster whose center is closest to it. In various implementations, new text inputs and/or outputs (for example, from the first artificial intelligence model) may be vectorized and added to the feature space as a new feature, and the clustering algorithm may be used to assign the new feature to a cluster.

### Examples

The following paragraphs provide examples of systems, methods, and devices implemented in accordance with this specification.

Example 1. A system comprising: memory hardware storing instructions and processing hardware configured to execute the instructions, wherein the instructions include: providing an input data set to a first machine learning model to generate an output data set, performing preprocessing operations on the output data set to generate preprocessed data, embedding the preprocessed data to generate embedded data, performing secondary processing on the embedded data to generate labeled data, providing the labeled data to a second machine learning model to generate a classification, in response to the classification being above a threshold, transforming a graphical user interface to present the output data set to a user, and in response to the classification not being above the threshold, requesting a new output data set from the first machine learning model.

Example 2. A computer-implemented method comprising: providing an input data set to a first machine learning model to generate an output data set; performing preprocessing operations on the output data set to generate preprocessed data; embedding the preprocessed data to generate embedded data; performing secondary processing on the embedded data to generate labeled data; providing the labeled data to a second machine learning model to generate a classification; in response to the classification being above a threshold, transforming a graphical user interface to present the output data set to a user; and in response to the classification not being above the threshold, requesting a new output data set from the first machine learning model.

Example 3. A system comprising: memory hardware storing instructions and processing hardware configured to execute the instructions, wherein the instructions include: providing an input data set to a first machine learning model to generate an output data set, performing preprocessing operations on the output data set to generate preprocessed data, embedding the preprocessed data to generate embedded data, performing secondary processing on the embedded data to generate labeled data, providing the labeled data to a second machine learning model to generate a classification, in response to the classification being above a threshold, saving the first machine learning model as a validated machine learning model, and in response to the classification not being above the threshold, adjusting parameters of the first machine learning model.

Example 4. A computer-implemented method comprising: providing an input data set to a first machine learning model to generate an output data set; performing preprocessing operations on the output data set to generate preprocessed data; embedding the preprocessed data to generate embedded data; performing secondary processing on the embedded data to generate labeled data; providing the labeled data to a second machine learning model to generate a classification; in response to the classification being above a threshold, saving the first machine learning model as a validated machine learning model; and in response to the classification not being above the threshold, adjusting parameters of the first machine learning model.

Example 5. A system comprising: memory hardware storing instructions and processing hardware configured to execute the instructions, wherein the instructions include: generating a first data set indicative of valid responses from a first artificial intelligence model, performing preprocessing on members of the first data set, vectorizing preprocessed members of the first data set, generating a second data set indicative of invalid responses from the first artificial intelligence model, performing preprocessing on members of the second data set, vectorizing preprocessed members of the second data set, providing vectorized preprocessed members of the first data set and vectorized preprocessed members of the second data set to a second machine learning model, wherein the second machine learning model is configured to determine whether an input data set is valid or invalid, calculating an accuracy for the second machine learning model based on results of the second machine learning model processing the vectorized preprocessed members of the first data set and the vectorized preprocessed members of the second data set, in response to the accuracy not being above a threshold, adjusting parameters of the second machine learning model, and in response to the accuracy being above the threshold, saving the second machine learning model as a trained machine learning model.

Example 6. A system comprising: memory hardware storing instructions and one or more electronic processors configured to execute the instructions, wherein the instructions include: providing a plurality of training inputs to a first artificial intelligence model to generate a plurality of training outputs, preprocessing the plurality of training inputs and/or training outputs, labeling one or more of the plurality of preprocessed training inputs and/or training outputs, organizing the preprocessed training inputs and/or training outputs as labeled and unlabeled features in a feature space based on proximity using a second artificial intelligence model, providing a test input to the first artificial intelligence model to generate a test output, preprocessing the test output, adding the preprocessed test output to the feature space as a test feature using the second artificial intelligence model, selecting labeled features in the feature space within a radius of the test feature, computing a first metric corresponding to a count of the selected labeled features, computing a second metric corresponding to distances between the selected labeled features and the test feature, computing a risk score based on the first metric and the second metric, in response to the risk score being above a threshold, assigning a first label to the test output, wherein the first label is indicative of an erroneous output from the first artificial intelligence model, and in response to the risk score not being above the threshold, (i) assigning a second label to the test output and (ii) transmitting the test output to a user device, wherein the second label is indicative of a non-erroneous output from the first artificial intelligence model.

Example 7. The system of example 6, wherein: the first artificial intelligence model includes a large language model; the plurality of training inputs includes one or more input text strings; and the plurality of training outputs includes one or more output text strings.

Example 8. The system of example 7, wherein preprocessing the plurality of training inputs and/or training outputs includes applying at least one of stemming, lemmatization, stop word removal, part-of-speech tagging, and tokenization operations to the plurality of training inputs and/or training outputs.

Example 9. The system of example 8, wherein labeling one or more of the plurality of preprocessed training inputs and/or training outputs includes at least one of: assigning a third label to each preprocessed training input and/or training output that contains a term present in a list; assigning a fourth label to each preprocessed training input and/or training output marked by a user; and assigning a fifth label to each preprocessed training input and/or training output conforming to a criteria.

Example 10. The system of example 9, wherein organizing the preprocessed training inputs and/or training outputs as labeled and unlabeled features in a feature space based on proximity using a second artificial intelligence model includes: generating feature vectors corresponding to each of the preprocessed training inputs and/or preprocessed training outputs; generating a graph with each feature vector as a node; generating edges between the nodes based on distances between feature vectors corresponding to the nodes; applying a graph neural network to the graph to allow each node to aggregate information from its neighbors; and training the graph neural network using the labeled features.

Example 11. The system of example 10, wherein generating feature vectors corresponding to each of the preprocessed training inputs and/or preprocessed training outputs includes transforming text of each of the preprocessed training inputs and/or preprocessed training outputs into a numerical vector in a high-dimensional space.

Example 12. The system of example 9, wherein organizing the preprocessed training inputs and/or training outputs as labeled and unlabeled features in a feature space based on proximity using a second artificial intelligence model includes: generating feature vectors corresponding to each of the preprocessed training inputs and/or training outputs; computing a distance matrix representing pairwise distances between feature vectors; constructing a graph with each node representing a feature vector, wherein edges are drawn between nodes that are proximate in the feature space; applying a clustering algorithm to the graph to determine cluster centers of clusters of nodes; and assigning each node to a cluster corresponding to a nearest cluster center.

Example 13. The system of example 9, wherein: the test input includes one or more input text strings and the test output includes one or more output text strings.

Example 14. The system of example 13, wherein preprocessing the test output includes applying at least one of stemming, lemmatization, stop word removal, part-of-speech tagging, and tokenization operations to the test output.

Example 15. The system of example 14, wherein the second metric represents a sum of distances between the test feature and each selected label feature.

Example 16. A computed-implemented method comprising: providing a plurality of training inputs to a first artificial intelligence model to generate a plurality of training outputs; preprocessing the plurality of training inputs and/or training outputs; labeling one or more of the plurality of preprocessed training inputs and/or training outputs; organizing the preprocessed training inputs and/or training outputs as labeled and unlabeled features in a feature space based on proximity using a second artificial intelligence model; providing a test input to the first artificial intelligence model to generate a test output; preprocessing the test output; adding the preprocessed test output to the feature space as a test feature using the second artificial intelligence model; selecting labeled features in the feature space within a radius of the test feature; computing a first metric corresponding to a count of the selected labeled features; computing a second metric corresponding to distances between the selected labeled features and the test feature; computing a risk score based on the first metric and the second metric; in response to the risk score being above a threshold, assigning a first label to the test output, wherein the first label is indicative of an erroneous output from the first artificial intelligence model; and in response to the risk score not being above the threshold, (i) assigning a second label to the test output and (ii) transmitting the test output to a user device, wherein the second label is indicative of a non-erroneous output from the first artificial intelligence model.

Example 17. The method of example 16, wherein: the first artificial intelligence model includes a large language model; the plurality of training inputs includes one or more input text strings; and the plurality of training outputs includes one or more output text strings.

Example 18. The method of example 17, wherein preprocessing the plurality of training inputs and/or training outputs includes applying at least one of stemming, lemmatization, stop word removal, part-of-speech tagging, and tokenization operations to the plurality of training inputs and/or training outputs.

Example 19. The method of example 18, wherein labeling one or more of the plurality of preprocessed training inputs and/or training outputs includes at least one of: assigning a third label to each preprocessed training input and/or training output that contains a term present in a list; assigning a fourth label to each preprocessed training input and/or training output marked by a user; and assigning a fifth label to each preprocessed training input and/or training output conforming to a criteria.

Example 20. The method of example 19, wherein organizing the preprocessed training inputs and/or training outputs as labeled and unlabeled features in a feature space based on proximity using a second artificial intelligence model includes: generating feature vector corresponding to each of the preprocessed training inputs and/or preprocessed training outputs; generating a graph with each feature vector as a node; generating edges between the nodes based on distances between feature vectors corresponding to the nodes; applying a graph neural network to the graph to allow each node to aggregate information from its neighbors; and training the graph neural network using the labeled features.

Example 21. The method of example 20, wherein generating feature vectors corresponding to each of the preprocessed training inputs and/or preprocessed training outputs includes transforming text of each of the preprocessed training inputs and/or preprocessed training outputs into a numerical vector in a high-dimensional space.

Example 22. The method of example 19, wherein organizing the preprocessed training inputs and/or training outputs as labeled and unlabeled features in a feature space based on proximity using a second artificial intelligence model includes: generating feature vectors corresponding to each of the preprocessed training inputs and/or training outputs; computing a distance matrix representing pairwise distances between feature vectors; constructing a graph with each node representing a feature vector, wherein edges are drawn between nodes that are proximate in the feature space, wherein edges include weightings based on node or neighborhood properties; applying a clustering algorithm to the graph to determine cluster centers of clusters of nodes; and assigning each node to a cluster corresponding to a nearest cluster center.

Example 23. The method of example 19, wherein: the test input includes one or more input text strings and the test output includes one or more output text strings.

Example 24. The method of example 23, wherein preprocessing the test output includes applying at least one of stemming, lemmatization, stop word removal, part-of-speech tagging, and tokenization operations to the test output.

Example 25. The method of example 24, wherein the second metric represents a sum of distances between the test feature and each selected label feature.

Example 26. A non-transitory computer-readable storage medium comprising executable instructions, wherein the executable instructions cause an electronic processor to: provide a plurality of training inputs to a first artificial intelligence model to generate a plurality of training outputs; preprocess the plurality of training inputs and/or training outputs; label one or more of the plurality of preprocessed training inputs and/or training outputs; organize the preprocessed training inputs and/or training outputs as labeled and unlabeled features in a feature space based on proximity using a second artificial intelligence model; provide a test input to the first artificial intelligence model to generate a test output; preprocess the test output; add the preprocessed test output to the feature space as a test feature using the second artificial intelligence model; select labeled features in the feature space within a radius of the test feature; compute a first metric corresponding to a count of the selected labeled features; compute a second metric corresponding to distances between the selected labeled features and the test feature; compute a risk score based on the first metric and the second metric; in response to the risk score being above a threshold, assign a first label to the test output, wherein the first label is indicative of an erroneous output from the first artificial intelligence model; and in response to the risk score not being above the threshold, (i) assign a second label to the test output and (ii) transmit the test output to a user device, wherein the second label is indicative of a non-erroneous output from the first artificial intelligence model.

Example 27. The non-transitory computer-readable storage medium of example 26, wherein: the first artificial intelligence model includes a large language model; the plurality of training inputs includes one or more input text strings; and the plurality of training outputs includes one or more output text strings.

Example 28. The non-transitory computer-readable storage medium of example 27, wherein the executable instructions cause the electronic processor to preprocess the plurality of training inputs and/or training outputs by applying at least one of stemming, lemmatization, stop word removal, part-of-speech tagging, and tokenization operations to the plurality of training inputs and/or training outputs.

Example 29. The non-transitory computer-readable storage medium of example 28, wherein the executable instructions cause the electronic processor to label one or more of the plurality of preprocessed training inputs and/or training outputs by: assigning a third label to each preprocessed training input and/or training output that contains a term present in a list; assigning a fourth label to each preprocessed training input and/or training output marked by a user; and assigning a fifth label to each preprocessed training input and/or training output conforming to a criteria.

Example 30. The non-transitory computer-readable storage medium of example 29, wherein the executable instructions cause the electronic processor to organize the preprocessed training inputs and/or training outputs as labeled and unlabeled features in a feature space based on proximity using a second artificial intelligence model by: generating feature vector corresponding to each of the preprocessed training inputs and/or preprocessed training outputs; generating a graph with each feature vector as a node; generating edges between the nodes based on distances between feature vectors corresponding to the nodes; applying a graph neural network to the graph to allow each node to aggregate information from its neighbors; and training the graph neural network using the labeled features.

Example 31. The non-transitory computer-readable storage medium of example 30, wherein generating feature vectors corresponding to each of the preprocessed training inputs and/or preprocessed training outputs includes transforming text of each of the preprocessed training inputs and/or preprocessed training outputs into a numerical vector in a high-dimensional space.

Example 32. The non-transitory computer-readable storage medium of example 29, wherein the executable instructions cause the electronic processor to organize the preprocessed training inputs and/or training outputs as labeled and unlabeled features in a feature space based on proximity using a second artificial intelligence model by: generating feature vectors corresponding to each of the preprocessed training inputs and/or training outputs; computing a distance matrix representing pairwise distances between feature vectors; constructing a graph with each node representing a feature vector, wherein edges are drawn between nodes that are proximate in the feature space, wherein edges include weightings based on node or neighborhood properties; applying a clustering algorithm to the graph to determine cluster centers of clusters of nodes; and assigning each node to a cluster corresponding to a nearest cluster center.

Example 33. The non-transitory computer-readable storage medium of example 29, wherein: the test input includes one or more input text strings and the test output includes one or more output text strings.

Example 34. The non-transitory computer-readable storage medium of example 33, wherein the executable instructions cause the electronic processor to preprocess the test output by applying at least one of stemming, lemmatization, stop word removal, part-of-speech tagging, and tokenization operations to the test output.

Example 35. The non-transitory computer-readable storage medium of example 34, wherein the second metric represents a sum of distances between the test feature and each selected label feature.

### CONCLUSION

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more steps within any given method may be executed in a different order—or steps may be executed concurrently—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. However, the direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element.

Throughout this application, the term “module” or the term “controller” may be replaced with the term “circuit.” A “module” may refer to, be part of, or include processor hardware that executes code and memory hardware that stores code executed by the processor hardware. The term “module” may include one or more interference circuits. In various implementations, the interference circuits may implement wired or wireless interfaces that connect to or are part of communications systems. Modules may communicate with other modules using the interference circuits. In various implementations, the functionality of modules may be distributed among multiple modules that are connected via communications systems. For example, functionality may be distributed across multiple modules by a load balancing system. In various implementations, the functionality of modules may be split between multiple computing platforms connected by communications systems.

The term “code” may include software, firmware, and/or microcode, and may refer to programs, routines, functions, classes, data structures, and/or data objects. The term “memory hardware” may be a subset of the term “computer-readable medium.” The term computer-readable medium does not encompass transitory electrical or electromagnetic signals or electromagnetic signals propagating through a medium—such as on an electromagnetic carrier wave. The term “computer-readable medium” is considered tangible and non-transitory. Modules, methods, and apparatuses described in this application may be partially or fully implemented by a special-purpose computer that is created by configuring a general-purpose computer to execute one or more particular functions described in computer programs. The functional blocks, flowchart elements, and message sequence charts described above serve as software specifications that can be translated into computer programs by the routine work of a skilled technician or programmer.

It should also be understood that although certain drawings illustrate hardware and software as being located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or they may be distributed among different computing devices—such as computing devices interconnected by one or more networks or other communications systems.

In the claims, if an apparatus or system is claimed as including an electronic processor or other element configured in a certain manner, the claim or claimed element should be interpreted as meaning one or more electronic processors (or other element as appropriate). If the electronic processor (or other element) is described as being configured to make one or more determinations or one or execute one or more steps, the claim should be interpreted to mean that any combination of the one or more electronic processors (or any combination of the one or more other elements) may be configured to execute any combination of the one or more determinations (or one or more steps).

What is claimed is:

1. A system comprising:
memory hardware storing instructions; and
one or more electronic processors configured to execute the instructions, wherein the instructions include:
providing a plurality of training inputs to a first artificial intelligence model to generate a plurality of training outputs,
preprocessing the plurality of training inputs and/or training outputs,
labeling one or more of the plurality of preprocessed training inputs and/or training outputs,
organizing the preprocessed training inputs and/or training outputs as labeled and unlabeled features in a feature space based on proximity using a second artificial intelligence model,
providing a test input to the first artificial intelligence model to generate a test output,
preprocessing the test output,
adding the preprocessed test output to the feature space as a test feature using the second artificial intelligence model,
selecting labeled features in the feature space within a radius of the test feature,
computing a first metric corresponding to a count of the selected labeled features,
computing a second metric corresponding to distances between the selected labeled features and the test feature,
computing a risk score based on the first metric and the second metric,
in response to the risk score being above a threshold, assigning a first label to the test output, wherein the first label is indicative of an erroneous output from the first artificial intelligence model, and
in response to the risk score not being above the threshold, (i) assigning a second label to the test output and (ii) transmitting the test output to a user device, wherein the second label is indicative of a non-erroneous output from the first artificial intelligence model.

2. The system of claim 1, wherein:
the first artificial intelligence model includes a large language model;
the plurality of training inputs includes one or more input text strings; and
the plurality of training outputs includes one or more output text strings.

3. The system of claim 2, wherein preprocessing the plurality of training inputs and/or training outputs includes applying at least one of stemming, lemmatization, stop word removal, part-of-speech tagging, and tokenization operations to the plurality of training inputs and/or training outputs.

4. The system of claim 3, wherein labeling one or more of the plurality of preprocessed training inputs and/or training outputs includes at least one of:
assigning a third label to each preprocessed training input and/or training output that contains a term present in a list;
assigning a fourth label to each preprocessed training input and/or training output marked by a user; and
assigning a fifth label to each preprocessed training input and/or training output conforming to a criteria.

5. The system of claim 4, wherein organizing the preprocessed training inputs and/or training outputs as labeled and unlabeled features in a feature space based on proximity using a second artificial intelligence model includes:
generating feature vectors corresponding to each of the preprocessed training inputs and/or preprocessed training outputs;
generating a graph with each feature vector as a node;
generating edges between the nodes based on distances between feature vectors corresponding to the nodes;
applying a graph neural network to the graph to allow each node to aggregate information from its neighbors; and
training the graph neural network using the labeled features.

6. The system of claim 5, wherein generating feature vectors corresponding to each of the preprocessed training inputs and/or preprocessed training outputs includes transforming text of each of the preprocessed training inputs and/or preprocessed training outputs into a numerical vector in a high-dimensional space.

7. The system of claim 4, wherein organizing the preprocessed training inputs and/or training outputs as labeled and unlabeled features in a feature space based on proximity using a second artificial intelligence model includes:
generating feature vectors corresponding to each of the preprocessed training inputs and/or training outputs;
computing a distance matrix representing pairwise distances between feature vectors;
constructing a graph with each node representing a feature vector, wherein edges are drawn between nodes that are proximate in the feature space;
applying a clustering algorithm to the graph to determine cluster centers of clusters of nodes; and
assigning each node to a cluster corresponding to a nearest cluster center.

8. The system of claim 4, wherein:
the test input includes one or more input text strings, and
the test output includes one or more output text strings.

9. The system of claim 8, wherein preprocessing the test output includes applying at least one of stemming, lemmatization, stop word removal, part-of-speech tagging, and tokenization operations to the test output.

10. The system of claim 9, wherein the second metric represents a sum of distances between the test feature and each selected label feature.

11. A non-transitory computer-readable storage medium comprising executable instructions, wherein the executable instructions cause an electronic processor to:
provide a plurality of training inputs to a first artificial intelligence model to generate a plurality of training outputs;
preprocess the plurality of training inputs and/or training outputs;
label one or more of the plurality of preprocessed training inputs and/or training outputs;
organize the preprocessed training inputs and/or training outputs as labeled and unlabeled features in a feature space based on proximity using a second artificial intelligence model;
provide a test input to the first artificial intelligence model to generate a test output;
preprocess the test output;
add the preprocessed test output to the feature space as a test feature using the second artificial intelligence model;
select labeled features in the feature space within a radius of the test feature;
compute a first metric corresponding to a count of the selected labeled features;
compute a second metric corresponding to distances between the selected labeled features and the test feature;
compute a risk score based on the first metric and the second metric;
in response to the risk score being above a threshold, assign a first label to the test output, wherein the first label is indicative of an erroneous output from the first artificial intelligence model; and
in response to the risk score not being above the threshold, (i) assign a second label to the test output and (ii) transmit the test output to a user device, wherein the second label is indicative of a non-erroneous output from the first artificial intelligence model.

12. The non-transitory computer-readable storage medium of claim 11, wherein:
the first artificial intelligence model includes a large language model;
the plurality of training inputs includes one or more input text strings; and
the plurality of training outputs includes one or more output text strings.

13. The non-transitory computer-readable storage medium of claim 12, wherein the executable instructions cause the electronic processor to preprocess the plurality of training inputs and/or training outputs by applying at least one of stemming, lemmatization, stop word removal, part-of-speech tagging, and tokenization operations to the plurality of training inputs and/or training outputs.

14. The non-transitory computer-readable storage medium of claim 13, wherein the executable instructions cause the electronic processor to label one or more of the plurality of preprocessed training inputs and/or training outputs by:
assigning a third label to each preprocessed training input and/or training output that contains a term present in a list;
assigning a fourth label to each preprocessed training input and/or training output marked by a user; and
assigning a fifth label to each preprocessed training input and/or training output conforming to a criteria.

15. The non-transitory computer-readable storage medium of claim 14, wherein the executable instructions cause the electronic processor to organize the preprocessed training inputs and/or training outputs as labeled and unlabeled features in a feature space based on proximity using a second artificial intelligence model by:
generating feature vector corresponding to each of the preprocessed training inputs and/or preprocessed training outputs;
generating a graph with each feature vector as a node;
generating edges between the nodes based on distances between feature vectors corresponding to the nodes;
applying a graph neural network to the graph to allow each node to aggregate information from its neighbors; and
training the graph neural network using the labeled features.

16. The non-transitory computer-readable storage medium of claim 15, wherein generating feature vectors corresponding to each of the preprocessed training inputs and/or preprocessed training outputs includes transforming text of each of the preprocessed training inputs and/or preprocessed training outputs into a numerical vector in a high-dimensional space.

17. The non-transitory computer-readable storage medium of claim 14, wherein the executable instructions cause the electronic processor to organize the preprocessed training inputs and/or training outputs as labeled and unlabeled features in a feature space based on proximity using a second artificial intelligence model by:
generating feature vectors corresponding to each of the preprocessed training inputs and/or training outputs;
computing a distance matrix representing pairwise distances between feature vectors;
constructing a graph with each node representing a feature vector, wherein edges are drawn between nodes that are proximate in the feature space, wherein edges include weightings based on node or neighborhood properties;
applying a clustering algorithm to the graph to determine cluster centers of clusters of nodes; and
assigning each node to a cluster corresponding to a nearest cluster center.

18. The non-transitory computer-readable storage medium of claim 14, wherein:
the test input includes one or more input text strings and the test output includes one or more output text strings.

19. The non-transitory computer-readable storage medium of claim 18, wherein the executable instructions cause the electronic processor to preprocess the test output by applying at least one of stemming, lemmatization, stop word removal, part-of-speech tagging, and tokenization operations to the test output.

20. The non-transitory computer-readable storage medium of claim 19, wherein the second metric represents a sum of distances between the test feature and each selected label feature.
